(19) United States
(12) Patent Application Publication
(10) Pub. No.: US 2006/0212542 A1
(43) Pub. Date: Sep. 21, 2006

(54) Method and computer-readable medium for file downloading in a peer-to-peer network

(75) Inventors: Han Fang, Beijing (CN); Xiangyang Chen, Beijing (CN); Mingjian Yu, Beijing (CN); Zhenchun Li, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development Co., Ltd., Beijing (CN)

(21) Appl. No.: 11/200,439

(22) Filed: Aug. 9, 2005

Related U.S. Application Data
(60) Provisional application No. 60/662,131, filed on Mar. 15, 2005.

(51) Int. Cl. G06F 15/16

(52) U.S. Cl. 709/219

(57) ABSTRACT

A method and computer-readable medium for downloading content in a peer-to-peer network is provided. A client detects a download event associated with an identifier of a file and submits a query that includes an identifier of a file to an indexing server. The client receives a peer list including connectivity information of a peer node that has stored at least a portion of content of the file. The client then connects wit the peer node, and downloads the portion from the peer node.

### RELATED APPLICATION DATA

This patent application claims the benefit of provisional U.S. Patent Application Ser. No. 60/662,131, filed Mar. 15, 2005.

### BACKGROUND

In a client-server network adapted to provide content, such as hypertext markup language (HTML) pages to clients, many clients may concurrently connect with the server. The processing capacity of a server in such a network is limited. If the number of clients connected to the server exceeds the processing or transmission capacity of the server, the media server may be unable to provide a high quality of service to the clients, crash, discontinue service to clients, or refuse connections to clients.

Peer-to-peer networking solutions reduce or eliminate capacity deficiencies that are common in client/server network configurations. Peer-to-peer network technologies distribute processing and transmission demands among peer clients in the network. Thus, as a peer-to-peer network grows in size, so to does the processing and transmission capacity of the peer-to-peer network.

Client/server networks provide content from network entities at statically assigned network locations. Advantageously, a user desiring content made available in a client/server network need only know the network address at which the content is located. Peer-to-peer networks, on the other hand, are transient in nature and the location of content within a peer-to-per network will change over time as the network topology changes. Moreover, as particular peer-to-peer nodes exit the peer-to-peer network, content provided solely by the exiting peer-to-peer node is then unavailable in the peer-to-peer network. Thus, peer-to-peer networks are unattractive from a service provider's perspective as content provided in a peer-to-peer network may not be reliably and consistently available to peer-to-peer clients.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a client-server network that may provide data content to various clients;

FIG. 2 is a diagrammatic representation of an embodiment of a peer-to-peer network that facilitates data distribution;

FIG. 3 is a diagrammatic representation of an embodiment of a network system that facilitates delivery of content in a peer-to-peer network;

FIGS. 4A and 4B show diagrammatic representations of an embodiment of data block storage by clients of a peer-to-peer network;

FIG. 5 is a diagrammatic representation of an embodiment of a data structure that may be provided to clients of a network system that facilitates file downloading in a peer-to-peer network;

FIG. 6 is a diagrammatic representation of an embodiment of various functional modules of a central indexing server;

FIG. 7 is a diagrammatic representation of an embodiment of various functional modules of a client of a peer-to-peer network configured for delivery of content within a peer-to-peer network; and

FIG. 8 is a flowchart of an embodiment of a client processing routine that facilitates registration and login of a network client with a peer-to-peer network;

FIG. 9 is a flowchart of an embodiment of a client downloading routine that facilitates downloading in a peer-to-peer network; and

FIG. 10 is a flowchart of an embodiment a downloading process for downloading a file in a peer-to-peer network.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

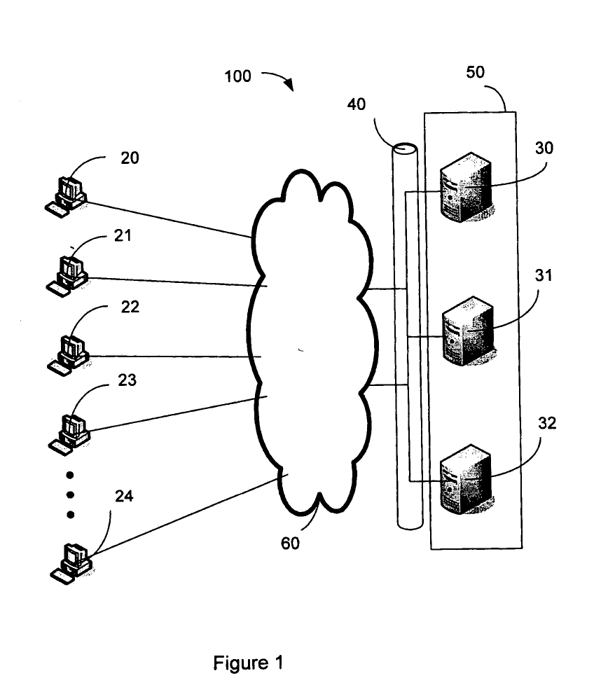

FIG. 1 is a diagrammatic representation of an embodiment of a client-server network 100 that may provide data services to various clients 20-24. Client-server network 100 comprises multiple content servers 30-32 configured in a cluster 50. Content servers 30-32 may store or otherwise access common content, such as hypertext markup language (HTML) pages, or other data structures. For example, content servers 30-32 may access and transmit web pages to clients connected therewith. Content servers 30-32 may be interconnected by a network link 40, such as an Ethernet. Services provided by cluster 50 may be load-balanced among content servers 30-32. Clients 20-24 are provided data content by connecting with cluster 50, for example by way of a public network 60, such as the Internet.

Each of content servers 30-32 may provide service processing for a finite number of clients, and thus the client service capacity of cluster 50 is limited to the aggregate service capacity of content servers 30-32. If the demand placed on cluster 50 becomes too large, the service quality provided to clients 20-24 may be degraded, one or more of clients 20-24 may be disconnected from cluster 50, or cluster 50 may reject clients from connecting therewith. Conventional solutions for addressing excessive loads placed on cluster 50 generally include expanding the processing capacity of cluster 50, for example by adding additional content servers to cluster 50, upgrading the capacity of existing content servers, or by other mechanisms. Such system reconfigurations are costly due to both hardware and labor expenses and do not address transmission capacity deficiencies of cluster 50.

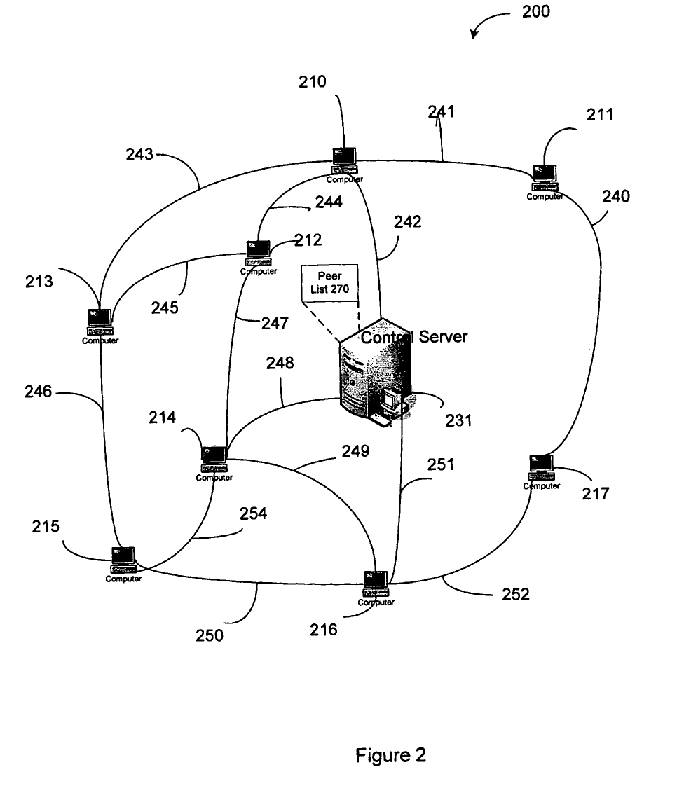

FIG. 2 is a diagrammatic representation of an embodiment of a peer-to-peer network 200 that facilitates downloading content in a peer-to-peer network. Network 200 includes various peer clients 210-217 that may be interconnected with other clients in network 200. Additionally, network 200 may include a control server 231. Peer clients 210-217 may distribute content, for example data structures, to other peer clients connected therewith. One or more clients may connect with control server 231 in addition to other network clients. Clients 210-217 may connect with other network clients and control server 231 by network connections 240-254, such as wire, wireless communication links, fiber optic cables, or other suitable network media.

Control server 231 may facilitate connection of new clients within network 200 and organize clients 210-217 that have joined network 200. Clients 210-217 may be implemented as data processing systems, such as personal computers, wired or wireless laptop computers, personal digital assistants, or other computational devices capable of network communications.

Control server 231 may generate a peer list 270 that includes connectivity information, such as a network address and port number, of respective peer clients that are connected within peer-to-peer network 200. When a peer client downloads an Internet file by, for example, the HTTP or FTP protocol, it submits a request to control server 231, with the identification of the file, and gets a peer list from the control server. The returned peer list may have the connectivity information of the peer clients which downloaded the same file in part or in whole.

A peer client, when joining peer-to-peer network 200, may report its cached file information and file segment information to control server 231. When exiting from peer-to-peer network 200, the peer client may notify the control server thereby allowing the control server to perform clearing work for the peer client.

In accordance with embodiments described herein, a network client, such as a client of a public network (e.g., the Internet) may be directed to download network-available content (or a portion thereof), from peer-to-peer network 200 entities, such as peer clients 210-217. Instructions for the network client to connect with a peer network may be implemented, for example, as directives of a web page or other data structure or instructions of an application run by the client, such as web browser instructions. In a preferred embodiment, a browser application includes instructions for detecting a download event associated with a file or other data structure that may be downloaded from a file server, and includes instructions for querying a control server in a peer-to-peer network to determine if the file is available in the peer-to-peer network. If the file is available in the peer-to-peer network, the file may be downloaded from peer node(s) of the peer-to-peer network rather than the file server. In other embodiments, a portion of the file may be downloaded from peer nodes and other portions may be downloaded from a file server.

Network 200 may comprise a transient Internet network, and thus clients 210-217 and control server 231 may use the Transmission Control Protocol/Internet Protocol (TCP/IP) suite of protocols to communicate with one another. Alternatively, network 200 may be implemented in any number of different types of networks, such as for example, an intranet, a local area network (LAN), or a wide area network (WAN). FIG. 2 is intended as an example, and not as an architectural limitation of embodiments described herein.

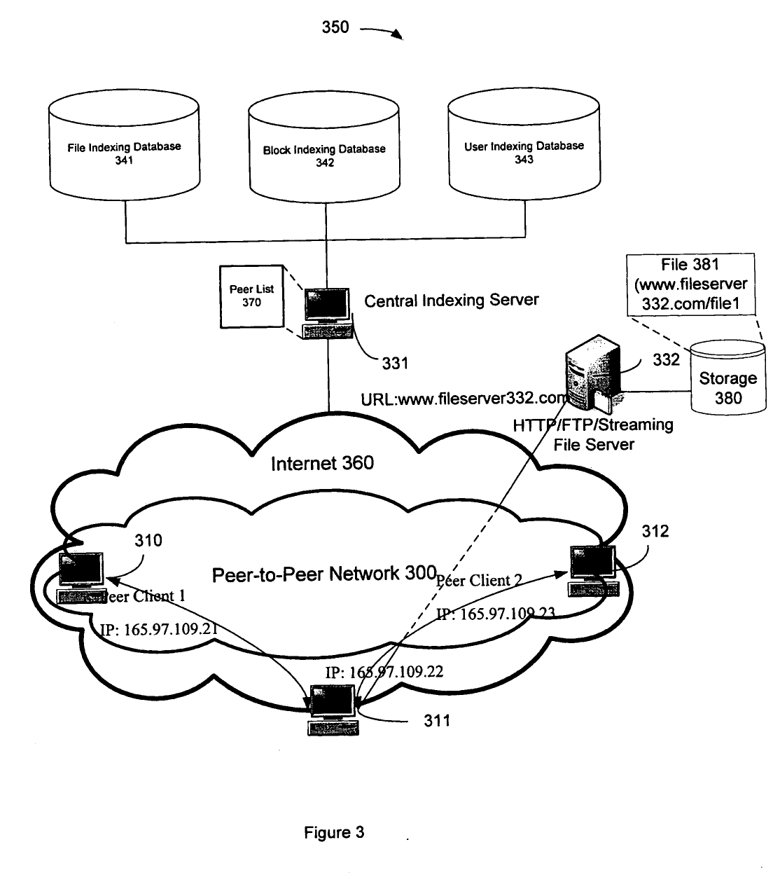

FIG. 3 is a diagrammatic representation of an embodiment of a network system 350 that facilitates delivery of content in a peer-to-peer network 300. Network system 350 comprises a network, such as a public network implemented as the Internet 360, on which peer-to-peer network 300 is deployed. In the illustrative example, clients 310-312 have respective IP network addresses of 165.97.109.21, 165.97.109.22, and 165.97.109.23. For illustrative purposes, assume that clients 310 and 312 are configured to participate in peer-to-peer network 300, and that client 311 is currently configured as an IP client of Internet 360.

Network system 350 features file server 332 that may provide content to clients of network 360. For example, file server 332 may be implemented as a hypertext transfer protocol (HTTP) server, a file transport protocol (FTP) server, or another server configuration adapted for delivery of data structures or content to clients thereof. Various other servers may be included in network system 350. In the illustrative example, file server 332 is accessed by Internet 360 and may provide content, such as a file 381 maintained in storage 380, to clients thereof. File 381 may be segmented and delivered by file server 332 to clients by way of a plurality of data segments or data blocks that each respectively contain a portion of the file content. In the illustrative example, file server 332 has a uniform resource locator (URL) of www.fileserver332.com that defines a location of file server 332 in Internet 360, and file 381 has a URL of www.fileserver332.com/file1. As referred to herein, a URL defines a network address or a network entity, such as a file server or a data structure (e.g., file 381) provided thereby, and thus provides an identifier of the network entity.

Network system 350 may include a central indexing server 331 (also referred to herein as a control server) that facilitates delivery of content by a peer-to-peer network for reducing the load placed on a content source, such as file server 332. Central indexing server 331 manages file information and block information of content that is stored in peer-to-peer network 300 that may be distributed between peer clients of peer-to-peer network 300. Additionally, central indexing server 331 manages user information of users (i.e., peer clients) logged into peer-to-peer network 300. For example, central indexing server 331 may maintain connectivity information of peer clients connected within peer-to-peer network 300. Central indexing server 331 may include or interface with a file indexing database 341, a block indexing database 342, and a user indexing database 343.

A peer client may request part of the file 381 from file server 332. When requesting part of the file, the peer client may specify a starting position and ending position of the file that is desired to be downloaded. For example, the peer client may specify a starting sequence number and an ending sequence number when desiring to download a portion of the file that spans from the specified starting and ending sequence numbers.

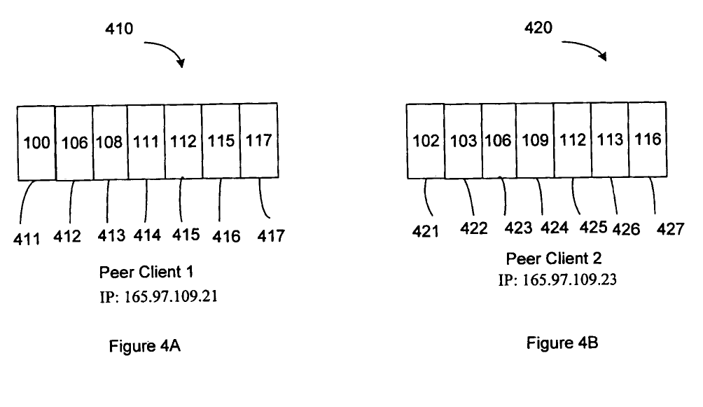

In accordance with embodiments described herein, content (or a portion thereof) of a file, such as file 381, may be distributed within peer-to-peer network 300 and maintained by clients thereof. FIGS. 4A and 4B show a diagrammatic representation of an embodiment of data block storage by clients of peer-to-peer network 300. Two respective exemplary client cache storages 410 and 420 are shown to facilitate an understanding of the embodiment. Client cache storage 410 is representative of a client cache of a first peer client (designated Peer Client 1 and represented as client 310 in FIG. 3), and client cache storage 420 is representative of a client cache of a second peer client (designated Peer Client 2 and represented as client 312 in FIG. 3). In the illustrative example, client cache storage 410 contains data blocks 411-417 each having a respective sequence number of 100, 106, 108, 111, 112, 115, and 117. Client cache storage 420 contains data blocks 421-427 having respective sequence numbers of 102, 103, 106, 109, 112, 113, and 116. Storage of data blocks 411-417 by Peer Client 1 and data blocks 421-427 by Peer Client 2 may be facilitated by a browser, a plug-in thereto, or another application program for distributing and storing data within peer network 300. Peer clients 310 and 312 may periodically report the particular data blocks cached thereby to central indexing server 331 that maintains records of the location of content within network 300. Peer clients may obtain content stored by other peer clients by submitting requests to peer clients. For example, peer client 310 may request and obtain data blocks 421, 422, 424, 426, and 427 (having respective sequence numbers of 102, 103, 109, 113, and 116) from peer client 312. Peer client 310 may then submit an update to indexing server 331 to provide an indication of the data blocks 421, 422, 424, 426, and 427 that have been received and cached thereby. For example, client 310 may submit an update message having a client identifier, such as an IP address (165.97.109.21 in the illustrative example), and a list or record of data blocks cached thereby. The update message may contain a comprehensive list of all data block sequence numbers cached by client 310 or changes (including deletions and additions) to cached data blocks since a previous report made by client 310. Indexing server 331 may then update records of file indexing database 341, block indexing database 342, and user indexing database 343 to properly indicate the most recent data blocks maintained by client 310. Other peer clients of peer-to-peer network 300 may similarly report content cached thereby to indexing server 331. In this manner, indexing server 331 maintains records of content (and the location thereof) that is stored in network 300.

Returning again to FIG. 3, file indexing database 341 comprises records of files that are stored within peer-to-peer network. File indexing database 341 may comprise records that include a file identifier, such as a URL, that is associated with the file and may include associated attribute information, such as file size, type, or other attribute data. A record is entered in file indexing database 341 for each file that is stored either in its entirety or an incomplete portion thereof within peer-to-peer network 300. Files that are completely stored within peer-to-peer network may or may not be stored by a single peer node. For example, different file portions or segments of a file may be stored by different peer nodes of peer-to-peer network 300, and the aggregate storage of multiple peer nodes may encompass the entirety of the file. Records within file indexing database may include a field or other data structure that indicates whether the file is completely stored within peer-to-peer network 300.

Block indexing database 342 comprises records that indicate particular data blocks of files that are stored within peer-to-peer network. For example, a record may be stored within block indexing database 342 that includes sequence numbers of data blocks of an associated file that are stored within peer-to-peer network 300. Records of indexing database 342 may be cross-linked or otherwise associated with records of file indexing database 341 such that data block sequence numbers may be correlated or logically associated with particular files. That is, records of block indexing database 342 may be associated with records of file indexing database 341 such that indexing server 331 may determine particular sequence numbers of data blocks of a particular file that are stored within peer-to-peer network 300.

User indexing database 343 may include records of client information for clients that are registered to participate within peer-to-peer network 300. For example, user indexing database 343 may include records that include identifiers assigned to clients when the clients are registered with peer-to-peer network 300, a status of the clients (such as logged in or logged out), client network connection speeds, client network addresses (such as IP addresses) or other client information. Records of user indexing database 343 may be cross-linked or otherwise associated with file indexing database 341 and block indexing database 342 to indicate the files (or segments thereof) and data block sequence numbers thereof that are maintained by the clients. Thus, indexing server 331 may identify clients, connectivity information thereof, and cached content thereof that is available for distribution to other clients within peer-to-peer network 300.

A client may connect with indexing server 331 and submit a query for a file. When a user clicks or otherwise selects a file link in a web page, a download request (or download event) may be generated. In accordance with embodiments, the download event is grabbed or otherwise identified and, in response thereto, a downloading procedure for downloading content in a peer-to-peer network is entered. The download event may be grabbed by a special configuration in a Registration Table, by installing code in the user (client) side that provides logic for implementing embodiments described herein, or by other suitable mechanisms. The query submitted to indexing server 331 may contain a unique identifier for the downloading file, such as a combination of the file URL, the file size and file's last modification date, or some variant formats of the combination, such as a product, such as a hash, of a message digest 5 (MD5) of the combination. The file size and the file's last modification date may be obtained from the file server according to the protocol of the file URL. By interrogating databases 341-343, file indexing server 331 can determine if any nodes within peer-to-peer network 300 have any content of the file available for transmission to clients within peer-to-peer network 300. Indexing server 331 may then generate a peer list that includes connectivity information of peer nodes (if any) that have at least a portion of the file available for transmission to the client. The peer list may include connectivity information of nodes in the peer-to-peer network, a server (e.g., file server 332) external to the peer-to-peer network, or both. Thus, the client may connect with one or more nodes in the peer list to download the file content that is available in the peer-to-peer network, and may connect with the file server external to the peer-to-peer network to download the portion of the file content that is unavailable for download in the peer-to-peer network. If none of the file content is available in the peer-to-peer network, the client may connect with the file server to download the file therefrom.

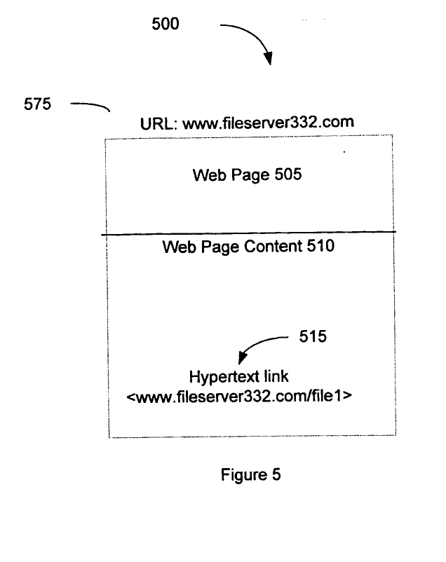

FIG. 5 is a diagrammatic representation of an embodiment of a data structure 500 that may be provided to clients of network system 350 that facilitates downloading of content in peer-to-peer network 300. Data structure 500 may be implemented as a web page 505, such as an HTML document, and includes web page content 510. Web page content 510 may be parsed from data structure 500 by a web browser run by a client and displayed on a display device.

Data structure 500 is associated with an identifier, such as a URL 575, that specifies a network location of data structure 500. In the illustrative example, URL 575 comprises a location of www.fileserver332.com, and is thus representative of a web page, such as a home page, provided to clients by server 332 upon establishment of a connection with a client via Internet 360.

A link 515, such as a hypertext link, may be included in web content 510 that references a file that may be downloaded to a client when the client selects (e.g., by a mouse click thereon) the link. In the illustrative example, link 515 comprises a hypertext link that is associated with the URL www.fileserver332.com/file1 and thus provides a logical reference to file 381 maintained in store 380 that is accessible by server 332.

Assume that client 311 connects with server 332 and receives data structure 500 that is displayed in a browser of client 311. The user may select, for example by performing a mouse click, link 515 for downloading file 381. Browser logic run by client 311 may detect selection of link 311 and initiate a peer-to-peer download of file 381 content (if any) that is stored in peer-to-peer network 300. An event that results in initiation of a file download is referred to herein as a download event. Thus, for example, a click event or other selection event performed on link 515 provides a download event for downloading file 381. As another example, a download event may comprise entry of a web page identifier into an application, such as entry of a URL associated with file 381 into an address field of a client browser. Thus, for example, entry of the URL www.fileserver332.com/file1 into a URL entry field of a browser comprises a download event that initiates access to file 381. Downloading of file 381 content in peer-to-peer network 300 may be performed in lieu of downloading file 381 from server 332 or may be performed in conjunction with downloading a portion of file 381 content from server 332.

In accordance with embodiments described herein, the client detects the download event and formulates a request for the associated file. The request is then transmitted to indexing server 331. For example, the request may include the URL www.fileserver332.com/file1 of data structure 500 referenced by link 515. Indexing server 331 may query file indexing database 341 and block indexing database 342 to determine if any clients within peer-to-peer network 300 have stored any content of file 381. If any peer clients of peer-to-peer network 300 are identified as having content of file 381, block indexing database 342 may be queried to identify the sequence numbers of data blocks that are stored within peer-to-peer network 300. A peer list containing connectivity information of peer clients that have content of file 381 and sequence numbers of data blocks stored thereby is then generated and returned to client 311. Client 311 may then select one or more (if any) of the peer clients that have content of file 381 and connect therewith for retrieval of the content. If no clients have any content of file 381, the client may then connect with file server 332 to retrieve file 381 therefrom. Preferably, client 311 may obtain a portion of file 381 from peers of network 300 and may obtain other portions of file 381 from file server 332 in the event that only a portion of file 381 content is available by peer clients of peer-to-peer network 300. By providing client 311 with connectivity information of peer clients that have any content of file 381, the load placed on file server 332 is advantageously reduced by distributing the processing and load demand required for delivery of file 381 (or a portion thereof) from file server 332 to nodes of peer-to-peer network 300. Moreover, the download of file 381 may be accelerated by providing multiple “sources” and corresponding connections for obtaining constituent portions of file 381.

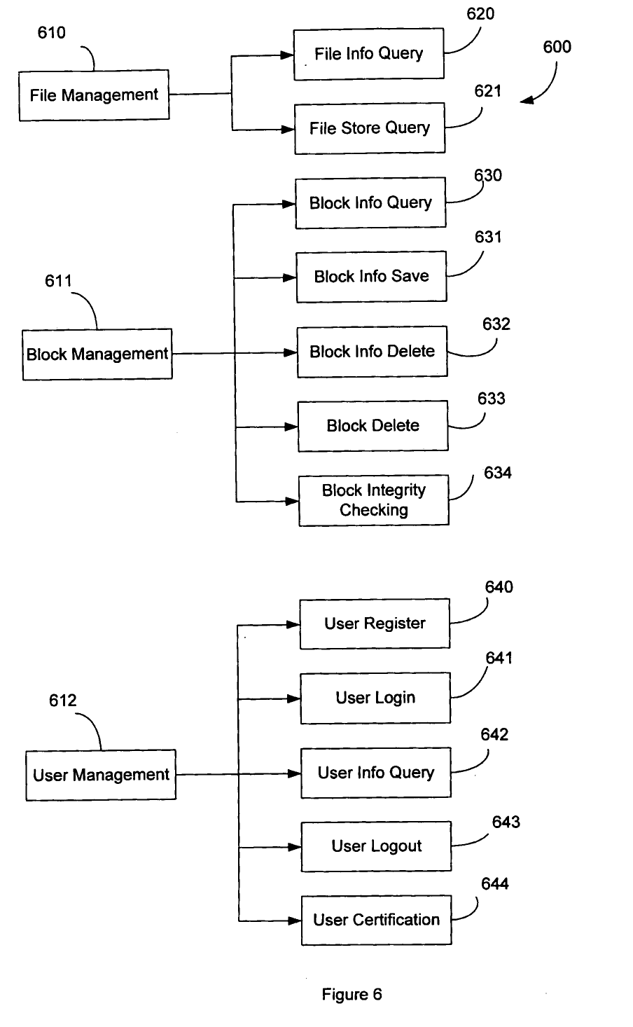

FIG. 6 is a diagrammatic representation of an embodiment of various functional modules 600 of central indexing server 331. In the illustrative example, central indexing server 331 comprises three independent modules: a file management module 610, a block management module 611, and a user management module 612. In the illustrative example, each of independent modules 610-612 comprises respective sub-modules 620-621, 630-634, and 640-644. Independent modules 610-612 (and sub-modules thereof) may be implemented as computer-executable instructions, such as one or more routines, subroutines, methods, or other instruction sets, that may be retrieved from a computer-readable medium and executed by a processing unit, such as a general purpose processing unit of indexing server 331.

File management module 610 provides functionality for managing file information, replying to requests supplied by clients of peer-to-peer network 300, completing operations related to client queries, and for performing indexing services related to information conveyed to indexing server 331 by peer clients. File information query sub-module 620 of file management module 610 comprises instructions that provide functionality for reading file identification information, block identification information, or other file information specified in a client request submitted to indexing server 331. For example, a client may submit a request to indexing server 331 for information related to distribution of a particular file within network 300 so that the client may download the file from peer clients of network 300. The request may specify a file, for example by way of an associated URL, and may include one or more sequence numbers of data block(s) of the file that the client desires to download. File information query sub-module 620 is adapted to parse the file information specified in the client request and to process the request, for example by querying one or more of database 341-343.

File storage query sub-module 621 provides functionality for updating data in one or more of databases 341-343 to reflect file distribution within network 300. For example, a client may download a file and, once the file download is complete, store the file (or a portion thereof) for later distribution to other peer clients. The client may report storage of the file to indexing server 331. File storage query sub-module 621 is adapted to read client information, file information, data block sequence number information, or other information related to the content stored by the client that is reported to indexing server 331, and file storage query sub-module 621 is adapted to update one or more of databases 341-343 to properly indicate information that describes attributes of the content storage by the client and information associated with the client.

Block management module 611 comprises instructions that provide functionality for executing works related to block operations. For example, block management module 611 may comprise logic for processing queries of user information for identification of block storage per user, block checksum operations, block information reporting, and the like.

Block information query sub-module 630 comprises instructions that provide functionality for processing queries to determine information regarding data blocks stored within peer-to-peer network 300. For example, block information query sub-module 630 may comprise logic for querying block indexing database 342 to determine if a data block having a particular sequence number is stored within peer-to-peer network 300, to determine a range of sequence numbers of data blocks stored within peer-to-peer network 300, or other information related to data blocks stored within peer-to-peer network 300.

Block information save sub-module 631 comprises instructions that provide functionality for maintenance of block information data related to data blocks stored in peer-to-peer network 300. For example, a client may report information to indexing server 331 that specifies an identity of the client, a file identity, block identities (e.g., sequence numbers) of data blocks of the identified file that the client has stored or other information related to content storage. Block information save sub-module 631 may interface with file indexing database 341, block indexing database 342, and/or user indexing database 343 to update records therein to properly indicate the particular data blocks stored by the reporting client, the client identity, or other information.

Block information delete sub-module 632 comprises instructions that provide functionality for updating records of one or more of file indexing database 341, block indexing database 342, and user indexing database 343 when data blocks have been deleted by a client in peer-to-peer network 300. For example, a client may delete particular blocks of file content stored thereby to, for example, provide file cache capacity for newly obtained content. The client may report to indexing server 331 the particular data blocks that have been deleted. Block information delete sub-module 632 may update records within block indexing database to reflect the deleted data blocks are no longer stored by the reporting client.

Block delete sub-module 633 comprises instructions that provide functionality for updating records of block indexing database to indicate one or more data blocks are no longer maintained in peer-to-peer network 300. For example, if a particular data block that has previously been stored by a single client of peer-to-peer network 300 is deleted by that particular client, block delete sub-module 633 may update block indexing database 342 to properly indicate the data block is no longer stored in peer-to-peer network 300.

Block integrity checking sub-module 634 comprises instructions that provide functionality for performing an integrity check of a data block reported to indexing server 331 by a peer client. For example, a client may transmit a report to indexing server 331 that indicates one or more data blocks have been stored by the client. The block integrity checking sub-module 634 may perform an integrity check on the reported data block(s), e.g., performing a checksum on the reported data block identification, in order to evaluate whether the data block reported may be erroneous. If the integrity check of the reported data block fails, block integrity checking sub-module 634 may prevent recording of the data block and associated user identification to prevent downloading of the data block by other peer clients.

User management module 612 comprises instructions that provide functionality for managing client's essential information for performing client registrations, login, logout, authentication, and other operations.

User register sub-module 640 comprises instructions that provide functionality for registering a client with indexing server 331. For example, a client may connect with indexing server 331 and submit a request to join peer-to-peer network 300. User register sub-module 640 may process the client request, add a record to user indexing database 343 that is associated with the client, assign a client identifier (ID) to the client, record connectivity information of the client in association with the client ID, record information to indicate the client is registered with peer-to-peer network 300, or provide other services that facilitate registration of the client within peer-to-peer network 300.

User login sub-module 641 comprises instructions that provide functionality for logging in a client that has been previously registered in peer-to-peer network 300. For example, user login sub-module 641 may update a client record to indicate the client is currently logged into peer-to-peer network 300, verify connectivity information of the client, record or update the network address of the client, or perform other operations that facilitate the client successfully logging into peer-to-peer network 300.

User information query sub-module 642 comprises instructions that provide functionality for querying user information from user indexing database 343. For example, user information query sub-module 642 may interrogate user indexing database 343 to determine which registered clients are currently logged into peer-to-peer network, obtain connectivity information of clients that are logged into peer-to-peer network 300 and that have particular content cached, or perform other operations that facilitate retrieval of client information from user indexing database 343.

User logout sub-module 643 comprises instructions that provide functionality for logging out a client from peer-to-peer network 300. For example, a client may submit a notification that the client is terminating a peer-to-peer session to indexing server 331. User logout sub-module 643 may update a client record in user indexing database 343 to indicate the client is currently logged out or otherwise unavailable for peer-to-peer distributions in peer-to-peer network 300.

User certification sub-module 644 comprises instructions that provide functionality for certifying a client within peer-to-peer network 300 (or that is logging into peer-to-peer network 300). For example, user certification sub-module 644 may comprise an authentication routine that verifies the identification of a client requesting to register or log into peer-to-peer network 300.

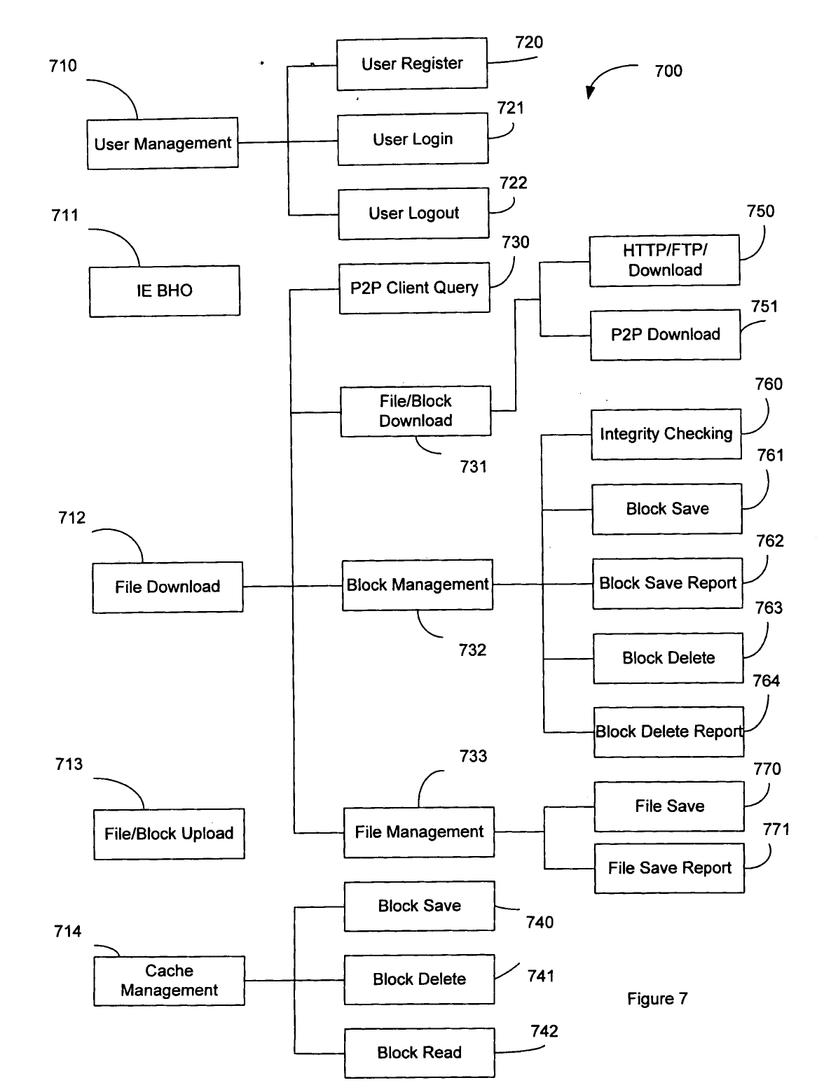

FIG. 7 is a diagrammatic representation of an embodiment of various functional modules 700 of a client of peer-to-peer network configured for delivery of content within peer-to-peer network 300. In the illustrative example, a client may be configured with various independent modules, such as a user management module 710, a browser helper object (BHO) module 711, a file download module 712, a file/block upload module 713, and a cache management module 714, and each independent may include one or more sub-modules. Independent modules 710-714 (and any sub-modules thereof) may be implemented as computer-executable instructions, such as one or more routines, subroutines, methods, or other instruction sets, that may be retrieved from a computer-readable medium and executed by a processing unit, such as a general purpose processing unit of client 310 shown in FIG. 3.

User management module 710 comprises instructions that provide functionality for managing a client's information necessary for operating within peer-to-peer network 300. For example, user management module may comprise instructions for performing client registrations in peer-to-peer network 300, login to peer-to-peer network 300, logout from peer-to-peer network 300, and other operations. In the illustrative example, user management module comprises three sub-modules: user register sub-module 720, user login sub-module 721, and user logout sub-module 722.

User register sub-module 720 comprises instructions that provide functionality for registering a client with indexing server 331. For example, a client that has not previously participated in peer-to-peer network 300 may be required to first register with indexing server 331 prior to being allowed to join peer-to-peer network 300. To this end, a client of network 350 may connect with indexing server 331 and submit a register request thereto. The registration request may include, for example, connectivity information of the client, or other identifying data associated with the client. In response to receiving a user register request, indexing server 331 may perform registration functions and return a client identification (client ID) that is recorded by the client and submitted to indexing server 331 during subsequent login procedures for client identification purposes.

User login sub-module 721 comprises instructions that provide functionality for logging a registered client into peer-to-peer network 300. For example, user login sub-module 721 generates a login request that includes connectivity information of the client and the client ID obtained when the client was registered with indexing server 331, and provides instructions for addressing and transmitting the login request to indexing server 331.

User logout sub-module 722 comprises instructions that provide functionality for logging out a client from peer-to-peer network 300. For example, user logout sub-module 722 may be invoked when a client's network connection is to be terminated, on receipt of an exit command in a peer-to-peer application, or in response to another event associated with a client terminating operations within peer-to-peer network 300. User logout sub-module 722 may generate a logout message that provides an indication the client is to be logged out of peer-to-peer network 300, connectivity information of the client, the client ID, or other information required for properly logging the client out of peer-to-peer network 300, and that transmits the logout request to indexing server 331.

BHO module 711 comprises instructions that may customize and control functions of browser 630. For example, BHO module 711 may be implemented as one or more dynamically linked libraries (DLLs) that monitor and control downloading of data within peer-to-peer network 300. BHO module 711 may invoke methods or other instructions in response to a download event, such as selection of a URL displayed in browser 630, that obtain information related to the event, e.g., the underlying URL associated with a selected link, and may obtain identification (e.g., a URL) of a file that is downloaded in response to a download event.

File download module 712 comprises instructions that provide functionality for downloading data in peer-to-peer network 300 and for facilitating management of the downloaded data. File download module 712 is responsible for formulating and sending queries to indexing server 331 in response to a download event, such as selection of a link associated with a URL or other file identifier, and for obtaining a peer list of client connectivity information from indexing server 331 to facilitate downloading of a file (or portion thereof) from nodes of peer-to-peer network 300.

File download module 712 may include a peer-to-peer client query sub-module 730 that provides functionality for sending a query request to indexing server 331 and receiving information returned from indexing server 331. For example, client query sub-module 730 may submit a request to indexing server 331 that specifies a particular file, e.g., by way of specifying a URL assigned to the file. Additionally, client query sub-module 730 may specify one or more data block sequence numbers (e.g., a range of data block sequence numbers) of a specified file that the client desires to download. Client query sub-module 730 may receive and process any response, such as a peer list, that is returned to the client from indexing server 331.

File/block download sub-module 731 comprises instructions that provide functionality for downloading a file (or a portion thereof, e.g., one or more data blocks of the file). File/block download sub-module 731 may provide logic for determining the particular mode by which the client will obtain a file (or a portion thereof). In a preferred embodiment, file/block download sub-module 731 may invoke a file server download mode, a peer-to-peer downloading mode, or a combination thereof. For example, if no peer nodes are identified as having content of a file to be obtained by the client, file/block download sub-module 731 may invoke file server download sub-module 750 that provides functionality for downloading, e.g., by HTTP or FTP, the file from a file server external to peer-to-peer network 300. For example, if no peer nodes currently logged into peer-to-peer network 300 have any content of a desired file, the client may connect with the file server from which the file originated, e.g., file server 332. File server download sub-module 750 includes logic for establishing connectivity with a file server, and processing content received therefrom.

In the event that content of a desired file is cached by one or more peer nodes in peer-to-peer network 300, file/block download sub-module 730 may invoke peer-to-peer download sub-module 751 to obtain the cached content from peer nodes. Peer-to-peer download sub-module 751 comprises logic for connecting with one or more peer nodes, submitting a request for content cached thereby, and processing content received from the peer node by way of peer-to-peer network 300.

Block management sub-module 732 comprises instructions that provide functionality for managing content received in a public network or peer-to-peer network and that may be made available for distribution to peer nodes of peer-to-peer network 300. Block management sub-module 732 may include integrity checking sub-module 760, block save sub-module 761, block save report sub-module 762, block delete sub-module 763, and block delete report sub-module 764.

Integrity checking sub-module 760 comprises instructions that provide functionality for performing an integrity check on a downloaded data block. For example, integrity checking sub-module 760 may perform a checksum calculation on each downloaded data block. A checksum for the corresponding data block may be obtained from indexing server 331, and integrity checking sub-module 760 may compare the checksum obtained from indexing server 331 and the checksum calculated from the downloaded data block. If the compared checksums are equivalent, the integrity checking sub-module 760 may determine that the downloaded data block is valid, and may invoke block save sub-module 761 in response to the determination that the downloaded data block is valid. If the compared checksums are not equivalent, the integrity checking sub-module 760 may determine that the downloaded data block is invalid and may invoke block delete sub-module 763 in response to the determination that the downloaded data block is invalid. Additionally, integrity checking sub-module 760 may invoke file/block download sub-module 731 to re-download the data block that has been identified as being invalid.

Block save sub-module 761 comprises instructions that provide functionality for saving a data block that has been obtained by the client and that has been identified as valid. For example, block save sub-module 761 may interface with file cache 650 shown in FIG. 6 and write a valid data block to file cache 650. Block save sub-module 761 may invoke block save report sub-module 762 in response to saving one or more data blocks.

Block save report sub-module 762 comprises instructions that provide functionality for generating a save report in response to a data blocks being saved by block save sub-module 761. For example, block save report sub-module 762 may generate a report that includes an identity, e.g., a data block sequence number and a corresponding file identifier (e.g., a URL associated with the file to which the save data block is associated), of a data block that has been saved by block save sub-module 761. Block save report sub-module 762 may include the client ID in the save report, address the save report to indexing server 331, and transmit the save report to indexing server 331 via peer-to-peer network 300.

Block delete sub-module 763 comprises instructions that provide functionality for deleting a data block that has been downloaded. For example, block delete sub-module 763 may delete a data block if the data block is determined to be invalid. Additionally, block delete sub-module 763 may delete a previously cached data block, for example to provide additional capacity for saving another data block. In the event that the deleted data block was previously reported as saved to indexing server 331, block delete sub-module 763 may invoke block delete report sub-module 764.

Block delete report sub-module 764 comprises instructions that provide functionality for generating a delete report in response to a data block being deleted by block delete sub-module 763. For example, block delete report sub-module 764 may generate a report that includes an identity, e.g., a data block sequence number and a corresponding file identifier (e.g., a URL associated with the file to which the deleted data block is associated), of a data block that has been deleted by block delete sub-module 763. Block delete report sub-module 764 may include the client ID in the delete report, address the delete report to indexing server 331, and transmit the delete report to indexing server 331 via peer-to-peer network 300.

File management sub-module 733 comprises instructions for managing saved files. For example, file management sub-module 733 may evaluate saved data blocks to determine if a complete file has been saved by the client. File management sub-module may additionally comprise instructions for assembling data blocks into a file structure in the event all constituent data blocks of a file have been downloaded. The assembled file may then be saved as the file data structure by file management sub-module 733. File management sub-module 733 may include a file save sub-module 770 and a file save report sub-module 771.

File save sub-module 770 comprise instructions that provide functionality for evaluating attributes of downloaded data blocks to determine if all constituent data blocks of a file have been downloaded by the client. For example, file save sub-module 770 may evaluate a range of sequence numbers to determine if all data blocks of a file have been downloaded. Alternatively, or in addition thereto, file save sub-module 770 may evaluate the size, e.g., the number of bytes, of data blocks of a particular file to determine if the complete file has been downloaded. In the event that it is determined that all constituent data blocks of a file have been downloaded by the client, file save sub-module 770 may assemble the saved data blocks in order according to the data blocks' sequence numbers, perform other additional file construction operations such as header generation or manipulation, and save the file data structure in the client's file cache. File save sub-module 770 may invoke file save report 771 in response to completion of a file save operation.

File save report sub-module 771 comprises instructions that provide functionality for generating a file save report in response to completion of a file save operation performed by file save sub-module 770. For example, file save report sub-module 771 may generate a report that includes a file identity, e.g., a file identifier such as a URL associated with the file that has been saved by file save sub-module 770. File save report sub-module 771 may include the client ID in the file save report, address the file save report to indexing server 331, and transmit the file save report to indexing server 331 via peer-to-peer network 300.

File/block upload module 713 comprises instructions that provide functionality for uploading file data blocks to requesting peer clients. For example, file/block upload module 713 may process a request received by the client from another peer node for a file (or a portion thereof such as one or more data blocks of the file). File/block upload module 713 may then retrieve the file (or data blocks) from the client's file cache, format the retrieved data blocks for transmission to the requesting peer client, and transmit the data blocks to the requesting client by way of peer-to-peer network 300. For example, one or more data blocks may be retrieved from the client's file cache and encapsulated in one or more peer network transport format frames or packets. File/block upload module 713 may address the network transport formatted frames to the requesting client and transmit the network transport formatted frames to the requesting client.

Cache management module 714 comprises instructions for managing a file cache that may maintain files or data blocks containing content of a file for distribution to peer clients in peer-to-peer network 300. Cache management module 714 may be responsible for saving downloaded data blocks to a client file cache, deleting data blocks from the file cache, and reading cached data blocks. Cache management module 714 may include block save sub-module 740, block delete sub-module 741, and block read sub-module 742.

Block save sub-module 740 comprises instructions for saving a data block to the client's file cache. Block save sub-module 740 may be invoked upon download of a data block from a file server or peer client. Block save sub-module 740 writes a saved data block to the client's file cache. Additionally, block save sub-module 740 may generate or update an index file to the client's file cache that facilitates location of the cached file data block.

Block delete sub-module 741 comprises instructions for deleting a data block from a client's file cache. For example, block delete sub-module 741 may delete a data block to provide file cache capacity for other data blocks to be saved. Block delete sub-module 741 may locate a data block in the client's file cache to be deleted by reading or evaluating a file index that provides references to data blocks in the client's file cache.

Block read sub-module 742 comprises instructions for reading data blocks from the client's file cache. Block read sub-module 742 may be invoked, for example, when a data block is requested by another peer client. Block read sub-module may read or evaluate an index file that provides references to cached data blocks for locating the data block. Block read sub-module 742 then interfaces with the file cache and reads the data block therefrom.

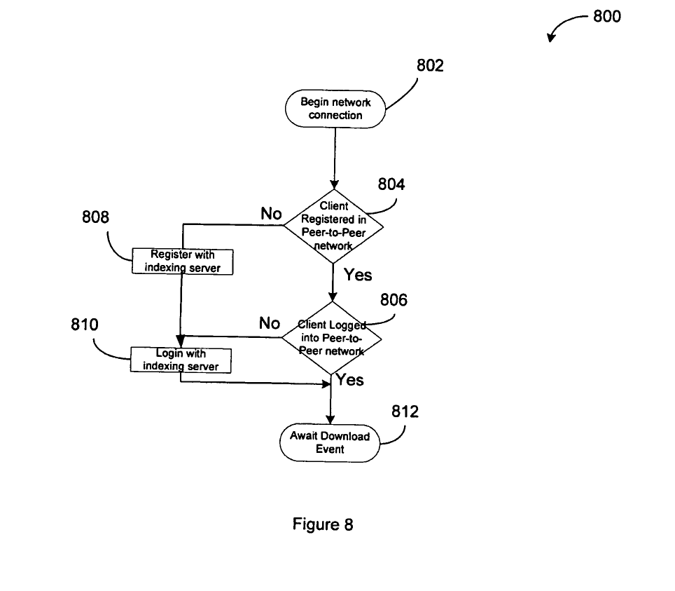

FIG. 8 is a flowchart of an embodiment of a client processing routine 800 that facilitates registration and login of a network client with a peer-to-peer network. The client processing routine depicted in FIG. 8 may be implemented as computer-executable instructions, such as one or more routines, subroutines, methods, or other instruction sets, that may be retrieved from a computer-readable medium and executed by a processing unit, such as a general purpose processing unit of client 310 shown in FIG. 3. The client processing routine may begin upon establishment of a network connection (step 802). An evaluation may be made to determine if the client is registered in the peer-to-peer network (step 804). In the event the client is registered in the peer-to-peer network, the client routine may proceed to evaluate whether the client is currently logged into the peer-to-peer network (step 806). If the client is not logged into the peer-to-peer network, the client routine may proceed to generate a login request and submit the login request to indexing server 331 (step 810), and thereafter proceed to await a download event (step 812). If it is determined that the client is logged into the peer-to-peer network at step 806, the client may proceed to await a download event according to step 812.

Returning again to step 804, if it is determined that the client is not registered in the peer-to-peer network, the client may then generate a registration request and submit the registration request to indexing server 331 (step 808). Thereafter, the client may proceed to login to the peer-to-peer network according to step 810.

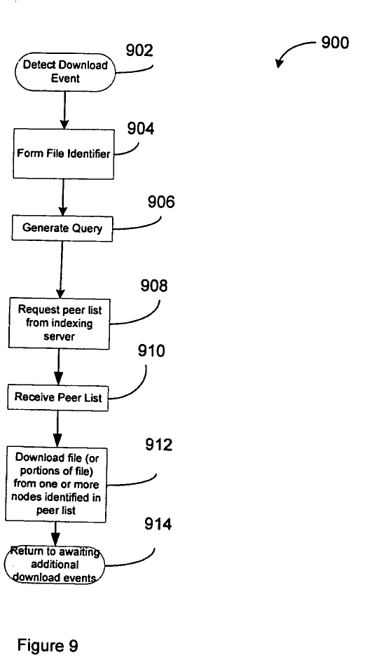

FIG. 9 is a flowchart 900 of an embodiment of a client downloading routine 900 that facilitates downloading in a peer-to-peer network. Downloading routine 900 may be implemented as computer-executable instructions, such as one or more routines, subroutines, methods, or other instruction sets, that may be retrieved from a computer-readable medium and executed by a processing unit, such as a general purpose processing unit of client 310 shown in FIG. 3. Downloading routine 900 may be invoked upon detection of a download event (step 902). Upon detection of a download event, the client may generate or otherwise form a file identifier (step 904) and generate a query that includes the file identifier (step 906). The client may then request a peer list from the indexing server (step 908), e.g., by submitting the query generated in step 906 to the indexing server. The query generated by the client may additionally include the client identifier assigned to the client by indexing server 331, an IP address of the client, and one or more data block identifiers such as sequence numbers associated with data blocks desired to be downloaded by the client. The file identifier included in the query may comprise a URL assigned or otherwise associated with the file (or an identifier derived, or derived in part, therefrom). Once the query is submitted to the indexing server, the client awaits receipt of a peer list that is returned to the client from indexing server 331 (step 910).

The client may then select one or more nodes from the peer list and establish connections with the selected node(s) for downloading the file. The downloading routine may then return to an idle state to await an additional download event (step 914).

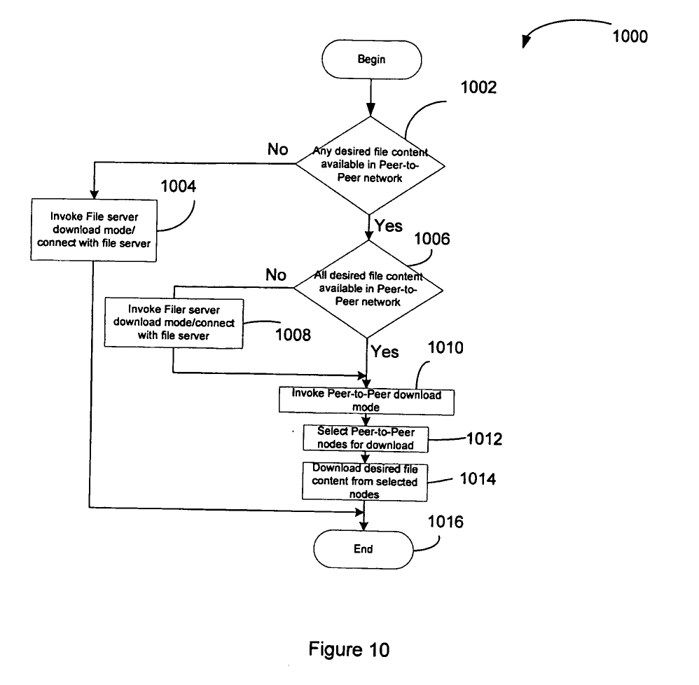

FIG. 10 is a flowchart 1000 of an embodiment a downloading process for downloading a file in a peer-to-peer network. The downloading process of FIG. 10 may be an implementation of the client downloading step 912 shown in FIG. 9 and may be implemented as computer-executable instructions, such as one or more routines, subroutines, methods, or other instruction sets, that may be retrieved from a computer-readable medium and executed by a processing unit, such as a general purpose processing unit of client 310 shown in FIG. 3

The downloading process of FIG. 10 may be invoked upon receipt of a peer list from indexing server 331. The client may evaluate the peer list to determine if any of the desired file content is located in peer-to-peer network 300 (step 1002). If no content of the desired file is located in peer-to-peer network 300, client processing may proceed to invoke a file server download mode by connecting with a file server having the desired file content and downloading the desired file content therefrom (step 1004). For example, if the client request was for file 381 shown in FIG. 3 and if no peer nodes of peer-to-peer network 300 have any content of file 381, the peer list returned to the client may include only connectivity information of file server 332. The client may retrieve the file server connectivity information from the peer list for establishing a connection with file server 381. The client may then download file 381 from file server 332, and the downloading process cycle may then end (step 1016).

Returning again to step 1002, in the event that it is determined that at least a portion of the desired file content is available in peer-to-peer network 300, the client processing routine may proceed to evaluate whether all the desired file content is available in peer-to-peer network 300 (step 1006). If it is determined that all the desired file content is not available in peer-to-peer network 300, the client processing routine may proceed to invoke the file server download mode and connect with the file server for downloading file content therefrom that is not available in peer-to-peer network 300 (step 1008). The client processing routine may then proceed to invoke a peer-to-peer download mode for downloading file content that is available in peer-to-peer network 300 (step 1010). Thus, even if all the file content is not available in peer-to-peer network 300, the client processing routine is able to download the portions of the file content that are available in peer-to-peer network 300 thereby advantageously reducing the load placed on the file server. Moreover, download of the file may be accelerated and may be more quickly completed when downloading the file from both the filer server and peer nodes of peer-to-peer network.

If it is determined that all the desired file content is available in peer-to-peer network 300 at step 1006, the client may invoke the peer-to-peer download mode according to step 1010. In response to invocation of the peer-to-peer download mode, one or more nodes of the peer-to-peer network are selected from the peer list (step 1012), and the client then connects with the selected nodes and downloads file content therefrom (step 1014). The client processing routine cycle may then end according to step 1016.

As described, embodiments provide a method and computer-readable medium for downloading file content in a peer-to-peer network. A download event is detected by a client, and an identifier of a file associated with the download event is included in a query that is submitted to an indexing server. The client receives a peer list that includes connectivity information of nodes that have at least a portion of the file available for transmission to the client. The peer list may include connectivity information of nodes in a peer-to-peer network, a server external to the peer-to-peer network, or both. If all file content to be downloaded by the client is available in the peer-to-peer network, the client may connect with one or more peer nodes identified in the peer list for downloading the file therefrom. If only part of the file content is available in the peer-to-peer network, the client may connect with one or more nodes in the peer list to download the file content that is available in the peer-to-peer network and may connect with the file server external to the peer-to-peer network to download the portion of the file content that is unavailable for download in the peer-to-peer network. If none of the file content is available in the peer-to-peer network, the client may connect with the file server to download the file therefrom.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of downloading content in a peer-to-peer network, comprising:
detecting a download event associated with an identifier of a file;
submitting a query that includes the identifier to an indexing server;
receiving a peer list including connectivity information of a peer node that has stored at least a portion of content of the file;
connecting with the peer node; and
downloading the portion from the peer node.

2. The method of claim 1, wherein receiving the peer list further comprises receiving the peer list including connectivity information of one or more file servers external to the peer-to-peer network.

3. The method of claim 2, further comprising:
connecting with the file server; and
downloading portions of the file from at least one of the one or more file servers.

4. The method of claim 1, further comprising generating the query in response to the download event being detected.

5. The method of claim 1, wherein detecting the download event comprises detecting a click event on a hypertext link, and wherein the identifier is a uniform resource locator associated with the hypertext link.

6. The method of claim 1, wherein the identifier is information comprising a combination of a uniform resource locator, a file size and a last modification time of the file.

7. The method of claim 6, wherein the identifier is a variant format of the information.

8. The method of claim 1, wherein detecting the download event comprises detecting entry of a uniform resource locator in a browser application.

9. A computer-readable medium having computer-executable instructions for execution by a processing system, the computer-executable instructions for downloading content in a peer-to-peer network, comprising:
instructions that detect a download event associated with an identifier of a file;
instructions that submit a query that includes an identifier of a file to an indexing server;
instructions that receive a peer list including connectivity information of at least one network entity that has stored at least a portion of content of the file;
instructions that connect with the peer node; and
instructions that download the portion from the peer node.

10. The computer-readable medium of claim 9, wherein the peer list includes connectivity information of one or more file servers external to the peer-to-peer network.

11. The computer-readable medium of claim 9, further comprising:
instructions that connect with the file server; and
instructions that download a second portion of the file from the file server.

12. The computer-readable medium of claim 9, further comprising instructions that generate the query in response to the download event being detected.

13. The computer-readable medium of claim 9, wherein the download event comprises a click event on a hypertext link, and wherein the identifier is a uniform resource locator associated with the hypertext link.

14. The computer-readable medium of claim 9, wherein the identifier comprises a combination of a uniform resource locator, a file size and a last modification time of the file.

15. The computer-readable medium of claim 14, wherein the information is a variant format of the combination.

16. The computer-readable medium of claim 9, wherein the download event comprises entry of a uniform resource locator in a browser application.

17. A device for downloading content in a network system, comprising:
a network interface;
a memory containing a browser implemented as a set of instructions; and
a processing unit that, in response to execution of the set of instructions, detects a download event, submits a query that includes an identifier of a file to an indexing server over the network interface, and determines whether a node in a peer-to-peer network has at least a first portion of the file.

18. The device of claim 17, wherein the processing unit connects with a file server that has the file stored and downloads a portion of the file from the file server.

19. The device of claim 17, wherein the identifier is a uniform resource locator, and wherein the file is located at the address specified by the uniform resource locator.

20. The device of claim 17, wherein the identifier comprises a combination of a uniform resource locator, a file size and a last modification time of the file.

21. The device of claim 17, wherein the identifier is a variant format of the combination.

22. The device of claim 17, wherein the identifier is a uniform resource locator and wherein the download event is a click event on a hypertext link associated with the uniform resource locator displayed in the browser.

23. The device of claim 17, wherein the identifier is a uniform resource locator and wherein the download event is an entry of the uniform resource locator in the browser.

24. A device adapted to download content in a network system, comprising:
means for detecting a download event associated with an identifier of a file;
means for submitting a query that includes the identifier to an indexing server;
means for receiving a peer list including connectivity information of a peer node that has stored at least a portion of content of the file;
means for connecting with the peer node; and
means for downloading the portion from the peer node
